(19) United States
(12) Patent Application Publication
(10) Pub. No.: US 2014/0214569 A1
(43) Pub. Date: Jul. 31, 2014

(54) TECHNIQUES FOR TRANSACTION QUANTITY CONTROL

(71) Applicant: NCR CORPORATION, Duluth, GA (US)

(72) Inventors: Priyamvada Patnaik, Alpharetta, GA (US); Russell Pruitt Herrington, JR., Monroe, GA (US)

(73) Assignee: NCR Corporation, Duluth, GA (US)

(21) Appl. No.: 13/755,103

(22) Filed: Jan. 31, 2013

(51) Int. Cl. G06Q 20/20

(52) U.S. Cl. CPC G06Q 20/201
USPC 705/20

(57) ABSTRACT

Techniques for transaction quantity control are provided. A transaction having multiple purchases for a same item type and having an adjustment in price is identified. An analysis on an adjustment condition results in dynamic splitting a line entry for the item into multiple sets, each set reflect a different aspect of the adjustment condition and a quantity identifier; and the sets together completely representing the adjustment condition.

### BACKGROUND

Consumers are increasingly using a variety of devices to interact with retailers. For example, consumers routinely research a retailer online before engaging a retailer in business. Nowadays, consumers can even use their own smartphones and tablet devices as kiosks to conduct business with enterprises and redeem offers.

However, customers are also becoming increasingly savvy when it comes to their purchases and are better and in some cases more information with respect to their purchases.

For example, consider when a customer receives a discount for a set amount off an item or certain quantity of items where the customer is purchasing multiple ones of the items in a given transaction. The number of items being purchased by the customer may not divide properly into the discount amount; as a result, existing information produced on a receipt or display screen (self-service or cashier-assisted) summarizing the transaction for the customer may be inaccurate or may be very confusing to the customer. Another example where inaccurate information can occur is when a customer receives a buy one get one free item with 3 or more items being purchased. In fact, if proper information were presented to the customer, the customer may elect not to use the discount and save it for another transaction altogether.

Displaying the proper adjustments when a quantity for an item is greater than 1 can be challenging from the enterprise. This is so because a variety of factors can be required to arrive at a proper price and proper discount from the quantity line entry (single line item showing a quantity attribute of greater than 1). Many times, enterprises will simply elect to list each purchased item on its own line (on the display or on the receipt), this can result in clutter that can cause the customer to miss other purchased items and is often times more confusing to the customer. In cases where receipts are produced it also wastes ink and papers thereby creating more refuse.

### SUMMARY

In various embodiments, techniques for transaction quantity control are presented. According to an embodiment, a method for quantity control is provided.

Specifically, an item listed in a transaction is detected as having a quantity value greater than 1. Next, a price adjustment is identified for the item. Finally, the item listed in the transaction is dynamically split into two or more independent line entries, at least one entry applying all or a portion of the price adjustment; each line entry and its supporting details presented for inspection during the transaction.

### BRIEF DESCRIPTION OF THE DRAWINGS

FIG. 1A is a diagram of a process flow for quantity control during an example transaction, according to an example embodiment.

FIGS. 1B-1D are sample screenshots depicting changes to a quantity attribute during the example transaction defined with the FIG. 1A, according to an example embodiment.

FIG. 2 is a diagram of a method for quantity control during a transaction, according to an example embodiment.

FIG. 3 is a diagram of another method for quantity control during a transaction, according to an example embodiment.

FIG. 4 is a diagram of a quantity control system, according to an example embodiment.

### DETAILED DESCRIPTION

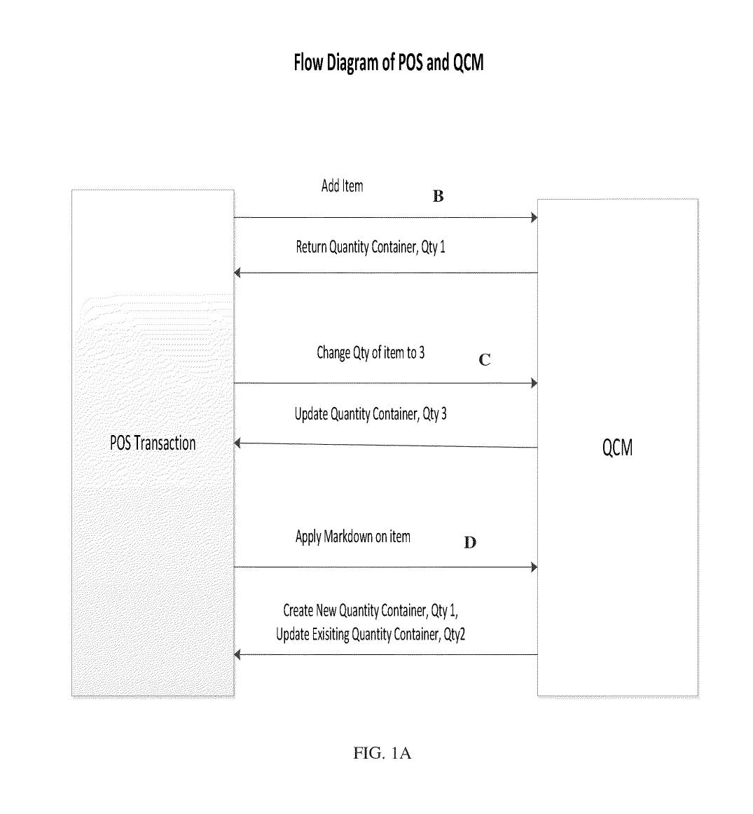

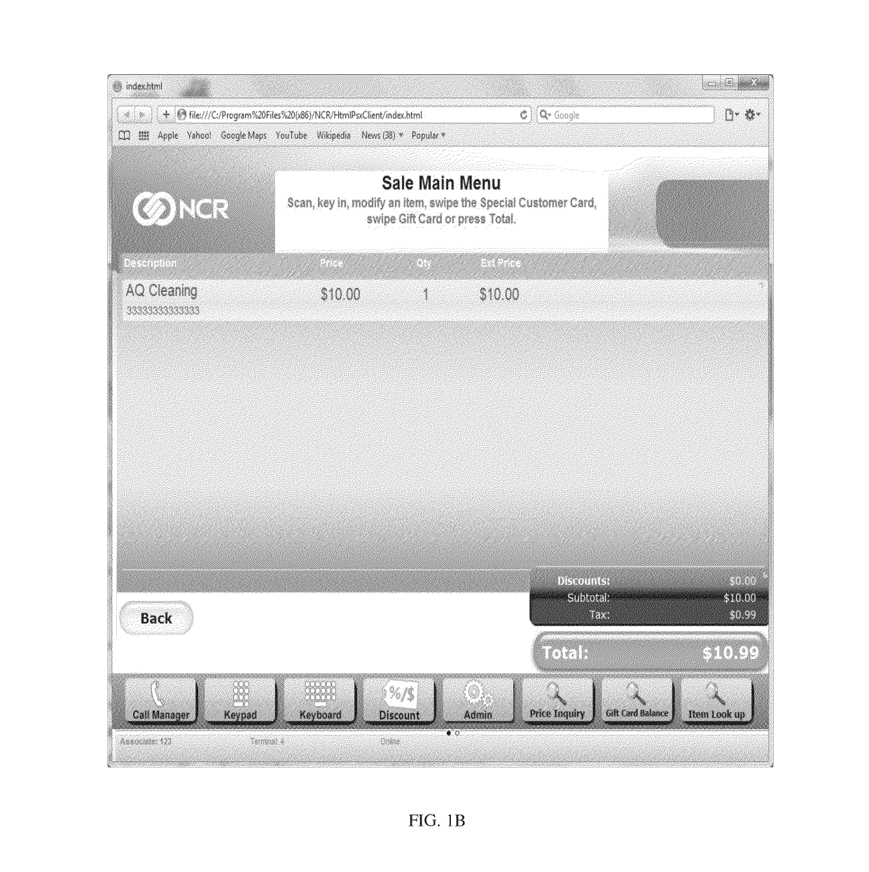

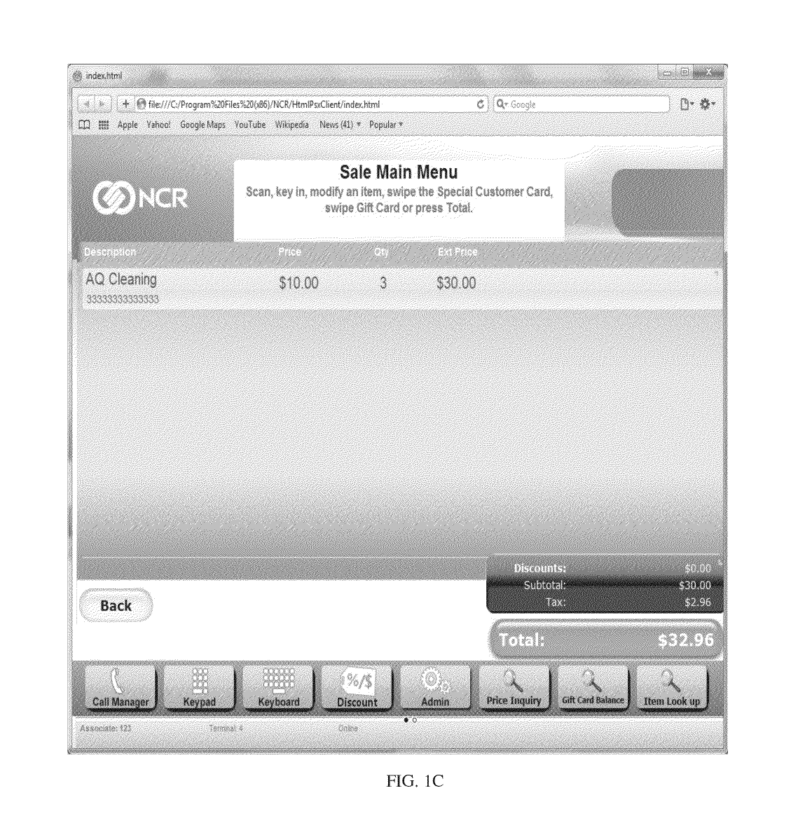

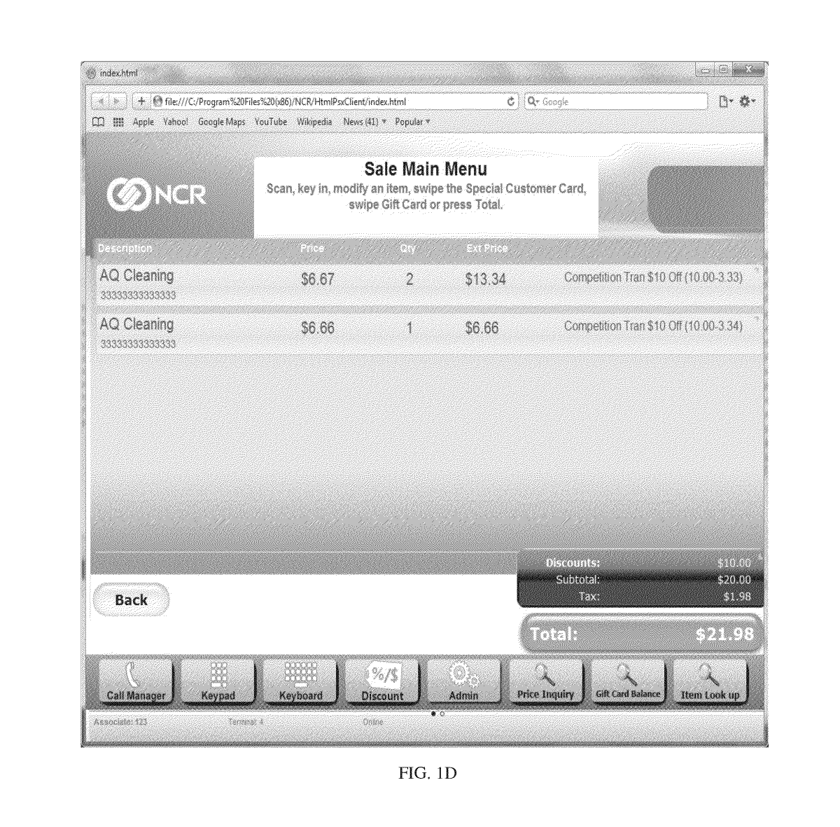

FIG. 1A is a diagram of a process flow for quantity control during an example transaction, according to an example embodiment. It is noted that the FIGS. 1A-1D are shown as an illustration for one example. The embodiments herein are not limited to this specific example.

Referring now to the process flow of the FIG. 1A, a Quantity Container Manager (shown as QCM in the FIG. 1A) is used to manage objects, such as items, and to determine when to create new objects based on changes to existing objects with quantity. The new objects are “cloned” from the existing object with the quantity attribute, and have the same properties as the existing object, except for the defining properties that changed for this new group of objects.

The QCM interacts with an enterprise's Point-Of-Sale (POS) Transaction System. The POS system can be kiosk based (in which case a consumer is directly interacting with the POS system) or the POS system can be cashier manned (in which case an employee of the enterprise is assisting a consumer in completing a transaction with the consumer).

A “Quantity Container” is defined, which is an object (such as an item with quantity) and whose properties are exactly the same as the object from which it was cloned.

The QCM evaluates each quantity container to determine when to separate a quantity of existing items into a new Quantity Container based on the defining properties of the item. The defining properties are used to determine when items can be grouped together on a line and when they are separated.

The process flow shown in the FIG. 1A is now discussed with reference to the sample screenshots of the FIGS. 1B-1D. FIG. 1A is labeled with B, C, and D; B corresponds to FIG. 1B, C corresponds to FIG. 1C, and D corresponds to FIG. 1D.

FIGS. 1B-1D are sample screenshots depicting changes to a quantity attribute during the example transaction defined with the FIG. 1A, according to an example embodiment.

FIGS. 1B-1D show screenshots for an example transaction involving quantity that changes based on a discount; the sample process flow for the screenshots was shown in the FIG. 1A above.

In the FIG. 1B, an item (AQ Cleaning) and a set initial quantity of 1 are presented on a screen for a POS transaction system.

In the FIG. 1C, the quantity for the item is changed to 3 for the one quantity container (single line on the POS transaction system for the item AQ Cleaning).

Next, a Transaction level discount of $10.00 is applied to the ongoing transaction in the POS transaction system; this results in 2 items having a discount of 3.33 cents each and 1 item having a discount of 3.34 cents (since $10 (discount amount) divided by 3 (quantity for the AQ Cleaning item) results in a repeating decimal one item's discount is modified to be different to get the $10 discount). So, in this case the price of one of the items is different.

The Quantity Container Manager creates a new quantity container for the item with $3.34 discount of qty (quantity) 1, and reduces the qty of the 1st item by the same quantity.

In the FIG. 1D, 2 Quantity Containers are presented on the screen, one with qty 2 and one with qty 1. Thus, the FIG. shows the POS transaction system after the QCM creates a new Quantity Container and adjusts for the discount appropriately.

The techniques herein allow for the use of quantity on an item and for managing real-time changes to the items.

All changes can be dynamically viewed by the cashier and/or customer in real time and during the transaction. This enables customers to view promotions that are applied on items and empowers them to make informed decisions about their purchase.

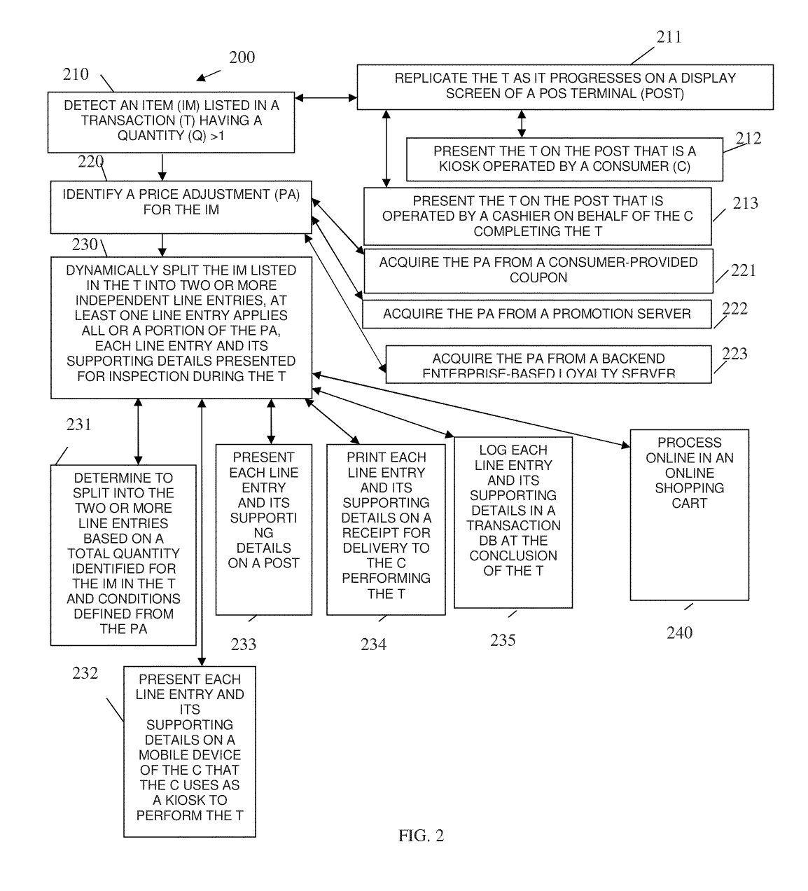

FIG. 2 is a diagram of a method 200 for quantity control during a transaction, according to an example embodiment. The method 200 (hereinafter “quantity controller”) is implemented as instructions programmed and residing in memory and/or on a non-transitory computer-readable (processor-readable) storage medium and executed by one or more processors of a device. The processors are specifically configured and programmed to process the quantity controller. The quantity controller operates over a network. The network is wired, wireless, or a combination of wired and wireless.

At 210, the quantity controller detects an item listed in a transaction having a quantity value (quantity) greater than 1. That is, a consumer performing a transaction with an enterprise is buying multiple items that are of the same type. For example, six cans of tomato soup. It is noted that the multiple items need not be identical; they can be classified by the enterprise from which they are being purchased as being a same type. So, a red ball may be classified as a same item type as a blue ball. The transaction occurs between a consumer and an enterprise.

According to an embodiment, at 211, the quantity controller replicates the transaction as it progresses on a display screen of a POS terminal. That is, as the transaction processes (either by direction of the consumer in a self-service scenario or by direction of a cashier in a cashier-assisted scenario), the transaction details (item description, quantity attributes, discounts, and price) appear on the display screen. It is noted that a cashier-assisted POS terminal may also include a Customer Information Display (CID) that permits the customer to view the details on the display screen in addition to a display screen being used by the cashier.

Continuing with the embodiment of 211 and at 212, the quantity controller presents the transaction on a POS terminal that is a kiosk operated by a consumer (self-service checkout).

In another case of 211 and at 213, the quantity controller presents the transaction on a POS terminal (can include a CID for the consumer to simultaneously view as well) that is operated by a cashier on behalf of a consumer completing the transaction.

At 220, the quantity controller identifies a price adjustment for the item (the item having a quantity greater than 1 in the transaction). The price adjustment can be identified and received in a variety of manners.

For example, at 221, the quantity controller acquires the price adjustment from a consumer-provided coupon. The coupon can be scanned from paper from a barcode on a display of a phone of the consumer or electronically transmitted from the phone of the consumer to a device processing the quantity controller.

In another scenario, at 222, the quantity controller acquires the price adjustment from a promotion server. The promotion server can be within the enterprise associated with the transaction or the promotion server can be a third-party service that the quantity controller interacts within over a network connection in real time during the transaction.

In yet another situation, at 223, the quantity controller acquires the price adjustment from a backend enterprise-based loyalty server. So, a price discount (price adjustment) can be resolved based on loyalty points or a loyalty level of the consumer for the transaction. The backend enterprise-based loyalty server dynamically consulted to acquire, apply, and if necessary deduct loyalty credits of the consumer.

At 230, the quantity controller dynamically splits the item description listed in the transaction into two or more independent line entries, where at least one line entry applies all or a portion of the price adjustment. Each line entry and its supporting details presented for inspection during the transaction. So, a line entry of “X having quantity of Y and a Price of Z” is dynamically split into two entries have the description, each having a quantity (the sum of which equals the original quantity), and different prices based on the extent to which the price adjustment was applied.

According to an embodiment, at 231, the quantity controller determines to split into the two or more line entries based on a total quantity identified for the item in the transaction and conditions defined from the price adjustment.

In an embodiment, at 232, the quantity controller presents each line entry and its supporting details on a mobile device of the consumer that the consumer uses as a kiosk to perform the transaction. In an embodiment, the kiosk is actually a phone or tablet owned and operated by the consumer via a mobile app that interfaces with the quantity controller.

In another case, at 233, the quantity controller presents each line entry and its supporting details on a POS terminal of an enterprise, this can be self-service or cashier assisted (can include a CID for the consumer/customer to view).

According to an embodiment, at 234, the quantity controller prints each line entry and its supporting details on a receipt for delivery to the consumer performing the transaction. This can be printed on traditional media or on thermal imaged media.

It is noted that in some instances, the receipt for the transaction having the two line entries and supporting details can also be emailed to the consumer by the quantity controller or posted to a history in an account of the consumer on a website associated with the enterprise for which the transaction is occurring.

In an embodiment, at 235, the quantity controller logs each line entry and its supporting details in a transaction database at the conclusion of the transaction.

According to an embodiment, at 240, the quantity controller processes online in a shopping cart application. So, the quantity controller can process on a POS terminal and in some cases that POS terminal is a website that is online.

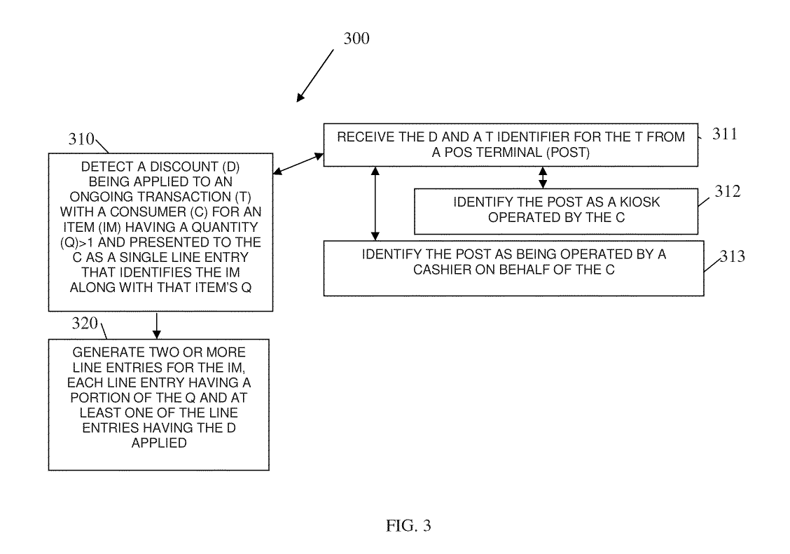

FIG. 3 is a diagram of another method 300 for quantity control during a transaction, according to an example embodiment. The method 300 (hereinafter “quantity manager”) is implemented as instruction and programmed within memory and/or a non-transitory computer-readable (processor-readable) storage medium that executes on one or more processors of a device; the processors of the device are specifically configured to execute the quantity manager. The quantity manager is also operational over a network; the network is wireless, wired, or a combination of wired and wireless.

The quantity manager shows another and in some ways an enhanced perspective of the quantity controller, discussed in detail above with reference to the FIG. 1.

At 310, the quantity manager detects a discount being applied to an ongoing transaction with a consumer for an item having a quantity greater than 1 (>1) and presented to the consumer as a single line entry that identifies the item along with that item's quantity.

According to an embodiment, at 311, the quantity manager receives the discount and a transaction identifier for the transaction from a POS terminal.

Continuing with the embodiment of 311 and at 313, the quantity manager identifies the POS terminal as a kiosk operated by the consumer of the transaction (the kiosk can be a mobile device of the consumer (phone, tablet, etc.) or the kiosk can be a traditional self-service device of an enterprise associated with the transaction).

In another case of 311 and at 313, the quantity manager identifies the POS terminal as being operated by a cashier on behalf of the consumer (cashier-manned checkout terminal and which can include a CID for the consumer to view a display as well as the cashier).

At 320, the quantity manager generates two or more line entries for the item in the transaction. Each line entry having a portion of the quantity (the sum of the quantities in the two or more line entries equals the original total quantity for the original single line entry). Moreover, at least one of the line entries having the discount applied. So, either a portion of the discount is applied to both lines or one line entry has the entire discount applied.

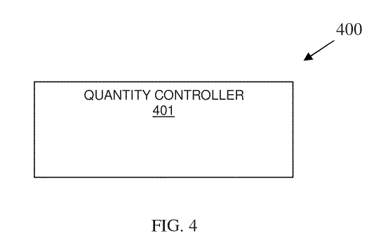

FIG. 4 is a diagram of a quantity control system 400, according to an example embodiment. The components of the quantity control system 400 are implemented as executable instructions and programmed within memory and/or a non-transitory computer-readable (processor-readable) storage medium that execute on one or more processors of a device; the processors are specifically configured to execute the components of the quantity control system 400. The quantity control system 400 is also operational over a network; the network is wired, wireless, or a combination of wired and wireless.

The quantity control system 400 includes a quantity controller 401.

The quantity control system 400 includes one or more processors of a device (server or client based machine). The device has memory configured with the quantity controller 401; the quantity controller 401 executes on the one or more processors. Example processing associated with the quantity controller 401 was presented in detail above with reference to the methods 100 and 200 of the FIGS. 1 and 2, respectively.

The quantity controller 401 is configured to dynamically split a single line entry having a quantity in a transaction for a given item into two or more line entries, each new line entry having a different quantity from the remaining line entry and at least one line entry having a price adjustment that is different from a price reflected in the remaining line entry.

According to an embodiment, the device is a kiosk, a mobile device of a consumer, or a cashier-manned Point-Of-Sale (POS) terminal operated by a cashier on behalf of the consumer.

In an embodiment, the quantity controller 401 is configured to perform one or more of: dynamically update a display presenting details of the transaction with the two or more line entries, log the details of the transaction with the two or more line entries to a transaction log, and print the details of the transaction with the two or more line entries.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in memory and/or a non-transitory processor-readable medium and to execute on one or more processors of a device configured to execute the method, comprising:
detecting, on the device, an item listed in a transaction having a quantity value greater than 1;
identifying, on the device, a price adjustment for the item; and
dynamically splitting, on the device, the item listed in the transaction into two or more independent line entries, at least one entry applying all or a portion of the price adjustment, each line entry and its supporting details presented for inspection during the transaction, each line entry having a specific quantity and different prices based on the price adjustment.

2. The method of claim 1, wherein detecting further includes replicating the transaction as it progresses on a display screen of a Point-Of-Sale (POS) terminal.

3. The method of claim 2, wherein replicating further includes presenting the transaction on the POS terminal that is a kiosk and operated by a consumer.

4. The method of claim 2, wherein replicating further includes presenting the transaction on the POS terminal that is operated by a cashier on behalf of a consumer completing the transaction.

5. The method of claim 1, wherein identifying further includes acquiring the price adjustment from a consumer-provided coupon.

6. The method of claim 1, wherein identifying further includes acquiring the price adjustment from a promotion server.

7. The method of claim 1, wherein identifying further includes acquiring the price adjustment from a backend enterprise-based loyalty server.

8. The method of claim 1, wherein dynamically splitting further includes determining to split into the two or more line entries based on a total quantity identified for the item in the transaction and conditions defined for the price adjustment.

9. The method of claim 1, wherein dynamically splitting further includes cloning a quantity container from an original line entry having the item and a total quantity identified for the item into an additional quantity container.

10. The method of claim 1, wherein dynamically splitting further includes presenting each line entry and its supporting details on a mobile device of a consumer that the consumer uses as a kiosk to perform the transaction.

11. The method of claim 1, wherein dynamically splitting further includes presenting each line entry and its supporting details on a Point-Of-Sale (POS) terminal.

12. The method of claim 1, wherein dynamically splitting further includes printing each line entry and its supporting details on a receipt for delivery to a consumer performing the transaction.

13. The method of claim 1, wherein dynamically splitting further includes logging each line entry and its supporting details in a transaction database at the conclusion of the transaction.

14. The method of claim 1 further comprising, processing, via the device, the method online in an online shopping cart service.

15. A processor-implemented method programmed in memory and/or a non-transitory processor-readable medium and to execute on one or more processors of a device configured to execute the method, comprising:
detecting, on the device, a discount being applied to an ongoing transaction with a consumer for an item having a quantity greater than 1 and presented to the consumer as a single line entry that identifies the item along with that item's quantity and the discount based on the quantity; and
generating, on the device, two or more line entries for the item, each line entry having a portion of the quantity and the two or more line entries showing portions of having the discount applied.

16. The method of claim 15, wherein detecting further includes receiving the discount and a transaction identifier for the transaction from a Point-Of-Sale (POS) terminal.

17. The method of claim 16, wherein receiving further includes identifying the POS terminal as a kiosk operated by the consumer.

18. The method of claim 16, wherein receiving further includes identifying the POS terminal as being operated by a cashier on behalf of the consumer.

19. A system, comprising:
memory having a quantity controller that processes as executable instructions on one or more processors of a device;
wherein the quantity controller is configured to dynamically split a single line entry having a quantity in a transaction for a given item into two or more line entries, each new line entry having a different quantity from the remaining line entry and the two or more line entries showing portions of a price adjustment that is different from a price reflected in the remaining line entry.

20. The system of claim 19, wherein the device is a kiosk, a mobile device of a consumer, or a cashier-manned Point-Of-Sale (POS) terminal operated by a cashier on behalf of the consumer.

21. The system of claim 19, wherein the quantity controller is configured to perform one or more of: dynamically update a display presenting details of the transaction with the two or more line entries, log the details of the transaction with the two or more line entries to a transaction log, and print the details of the transaction with the two or more line entries.
